(19) United States
(12) Patent Application Publication
(10) Pub. No.: US 2021/0172485 A1
(43) Pub. Date: Jun. 10, 2021

(54) COMMERCIAL VEHICLE AXLE WITH A DISC BRAKE

(71) Applicant: WABCO Europe BVBA, Brussels (BE)

(72) Inventor: Paul HENNING, Schwetzingen (DE)

(21) Appl. No.: 17/117,395

(22) Filed: Dec. 10, 2020

(30) Foreign Application Priority Data
Dec. 10, 2019 (EP) 19214816.1

(51) Int. Cl. F16D 55/226; F16D 65/092

(52) U.S. Cl. CPC F16D 55/226; F16D 65/18; F16D 65/092

(57) ABSTRACT

A truck axle may include a disc brake having a brake caliper and brake pads for application onto the brake disc. The brake caliper has a first interior space with an opening on the side facing the brake disc for receiving an application device, and the brake caliper has a second interior space for receiving the brake disc. The truck axle with the disc brake is optimized with respect to cost and installation space, wherein the disc brake can easily be mounted on a truck axle. A brake caliper includes bolt guides, and a wheel carrier includes guide bolts that receive the bolt guides thereon. An axial space is defined within a bolt guide hole between a base of the bolt guide hole and the end of the guide bolts disposed within the bolt guide hole. The guide bolts may be integral with or separately connected to the wheel carrier.

### FIELD

The present disclosure is directed to a commercial vehicle axle with a disc brake that has a brake caliper and brake pads for application onto the brake disc. More particularly, the brake caliper has a first interior space with an opening on the side facing the brake disc for receiving an application device, and the brake caliper has a second interior space for receiving the brake disc.

### BACKGROUND

Truck axles with a disc brake having a brake caliper and brake pads are known from DE 10 2012 016 712 A1. The disc brake has a brake caliper for a floating caliper disc brake. By way of two bolt guides in the brake caliper, the brake caliper slides axially in the direction of the brake disc on guide bolts of a brake carrier of the disc brake, and clamps the brake disc during a braking process. The brake carrier has two opposing brake pad shafts for receiving and arranging the brake pads. The brake pads are supported and guided so as to be axially displaceable in the brake carrier. The brake pads are held by a pad retaining bracket and retaining springs. The disadvantage of brake carriers for trucks, in particular heavy trucks, is the high unit weight of at least 9 kg. A first interior space of the brake carrier houses an actuator that is configured as an application device and that applies the brake pad on the application side via an opening of the first interior space. Modern application devices require a great deal of installation space in the brake caliper. The application side is the side of the disc brake on which the application device is arranged in the disc brake. The reaction side is the side of the disc brake opposite the application side. To correct pad wear on the brake pads, the application device of the disc brake has an adjustment device. The adjustment device is configured to maintain a constant air gap, i.e. the distance between the brake pad and the brake disc. In modern disc brakes, adjustment is automatic. The adjustment device, like the application device, is arranged in the first interior space of the brake caliper or in an additional interior space of the brake caliper configured as a box core, so that in order to receive the application device and adjustment device, the brake caliper must be dimensioned sufficiently large in the axial and radial directions.

Furthermore, truck axles are known for connection to the above-described disc brakes. On a wheel carrier, the truck axles have a first flange face and a second flange face for mounting a brake carrier of the disc brake. Both the brake carrier and the flange faces of the truck axle have passage openings, where the passage openings of the brake carrier and the passage openings of the truck axle are aligned. Two screw elements fix the brake carrier to the truck axle via the passage openings. A refinement of the connection of the disc brake to a truck axle is described in DE 10 2015 002 892 A1. DE 10 2015 002 892 A1 describes a solution for preventing premature loosening of a screw from the passage opening. The screw may be prematurely loosened for example by driving over poor road surfaces. DE 10 2015 002 892 A1 solves the problem in that the first passage opening has a smaller internal width in a first region than in a second region, where the first region lies closer to the first flange face than the second region. The disadvantage of the proposed solutions lies in the size of the disc brake and the necessary installation space in a truck for arranging the disc brake on a truck axle.

It has been found that, in particular because of the electrification of trucks, the truck axles and disc brakes previously fitted to a vehicle are too heavy and too large, and no longer meet current requirements for lightweight trucks with optimized installation space.

### SUMMARY

The object of the present disclosure is to provide a truck axle with a disc brake that is optimized with respect to cost and installation space, where the disc brake can easily be mounted on a truck axle.

The object is achieved by a truck axle having a disc brake with a brake caliper, where the brake caliper includes a first bolt guide and a second bolt guide, and the brake caliper is arranged on a wheel carrier of the truck via the first bolt guide and the second bolt guide. The direct connection of the brake caliper to the wheel carrier without an additional brake carrier reduces the installation space required for connecting the disc brake to the truck axle. The resulting available installation space may be filled with other components. The omission of the brake carrier of the disc brake reduces the total weight of the truck, such that this reduced total weight of the truck improves the fuel consumption of the truck.

In a further aspect of the disclosure, the first bolt guide has a bolt guide hole which is closed in the direction of a brake disc, or a bolt guide hole which is closed facing away from the brake disc, and the second bolt guide has a bolt guide hole which is closed in the direction of the brake disc or a further bolt guide hole facing away from the brake disc. The bolt guide holes which are closed on the brake disc side ensure that no dirt or debris, such as abraded material from the brake pads, can penetrate into the hole of the first bolt guide and the hole of the second bolt guide on the brake disc side. For simple production of the first bolt guide and second bolt guide, manufacture of the holes by way of a casting process has proved particularly advantageous. The bolt holes, which are cast during the manufacturing process of the brake caliper, may also be machined if necessary by way of a tool, for example a milling cutter. The holes are preferably configured as blind bores. Additional closure of the openings of the holes on the brake disc side is therefore not necessary.

In another aspect, the wheel carrier has a first guide bolt for receiving the first bolt guide thereon and the wheel carrier additionally has a second guide bolt for receiving the second bolt guide thereon. In one aspect, there is no additional flange face on the disc brake with this design. Also, no additional connecting devices are required for connecting the disc brake to the wheel carrier. These additional connecting devices would be, for example, screws or other releasable connecting devices or fasteners.

In another aspect, the first guide bolt and the second guide bolt are arranged on the wheel carrier by a method such as forging or casting. Said methods are particularly suitable for a permanent and heavily loaded connection between the wheel carrier and the first guide bolt and second guide bolt.

In another aspect, the first guide bolt is arranged on the wheel carrier via a first bolt screw and the second guide bolt is arranged on the wheel carrier via a second bolt screw. In this aspect, mounting of the disc brake onto or its removal from the wheel carrier of the truck can also be carried out in a small installation space, because the first guide bolt and second guide bolt are independent components and are fitted in the first bolt guide and in the second bolt guide independently of the wheel carrier.

In another aspect, it has proved advantageous that the first guide bolt is partially arranged in the bolt guide hole of the first bolt guide and the second guide bolt is partially arranged in the bolt guide hole of the second bolt guide. The base of the hole of the first bolt guide on the brake disc side and the first guide bolt guided partially into the hole are axially spaced apart from each other by a length of 20 mm. Also, the base of the hole of the second bolt guide and the second guide bolt guided partially into the hole are axially spaced apart from each other by an axial length of 20 mm. The axial length of 20 mm provides for an axial movement of the brake caliper in the direction of the brake disc or against the direction of the brake disc. The axial length is not fixed at 20 mm but may vary depending on requirements and the design of the disc brake, in particular the necessary brake pad thickness and brake disc wear dimension. The brake disc wear dimension is defined as the wear of the brake disc which occurs by the brake disc coming into contact with the brake pads.

In another aspect, the first guide bolt is formed at right angles to a flange face of the brake caliper and the second guide bolt is formed at right angles to a flange face of the brake caliper. The right-angled form of the first guide bolt and the right-angled form of the second guide bolt allow the disc brake to be forged or cast directly as one component onto the wheel carrier of the truck axle. The direct connection of the brake caliper to the truck axle allows for the omission of a brake carrier of the disc brake, such that more installation space is freed in the region of a wheel hub of the vehicle axle. To replace a brake disc of the disc brake, the disc brake is axially removed from the truck axle or mounted thereon with simultaneous axial removal of the brake disc. Also, however, the brake disc may be removed radially in the first step, and then the brake caliper may be axially removed from or installed on the truck axle.

In another aspect, the first guide bolt and the second guide bolt are formed so as to be rectilinear along the axial brake caliper axis. The rectilinear form of the first guide bolt and the rectilinear form of the second guide bolt have the advantage that the brake caliper, even with the brake disc pre-mounted on the truck axle, can be mounted or removed radially.

In a further aspect, the brake caliper is mounted on the wheel carrier via the first bolt guide and via the second bolt guide so as to slide axially along the brake caliper axis. The first guide bolt and the second guide bolt also have the function of moving the brake caliper along the axial brake caliper axis in the direction of the brake pads or against the direction of the brake pads of the axial brake caliper axis. The movement of the brake caliper is made possible by the 20 mm spacing between a blind hole base of the first bolt guide and the first guide bolt, and the 20 mm spacing between a blind hole base of the second bolt guide and the second guide bolt. Further guide bolts, or components such as a brake carrier for guiding the brake caliper, are not required.

In another aspect, a first sealing element is arranged around the circumference of the first guide bolt in the region of an opening of the bolt guide hole of the first bolt guide, and a second sealing element is arranged along the circumference of the second guide bolt in the region of an opening of a bolt guide hole of the second bolt guide. The seal limits and/or prevents the penetration of environmental influences such as dirt, snow, and water. The environmental influences may adversely affect the function of the first bolt guide with the first guide bolt, and of the second bolt guide with the second guide bolt. The first sealing element and the second sealing element therefore extend the life of the disc brake, because environmental influences cannot penetrate or can only penetrate to a limited extent through the first sealing element into the first bolt guide, and environmental influences cannot penetrate or can only penetrate to a limited extent through the second sealing element into the second bolt guide.

In another aspect, the first sealing element is attached via a groove formed on the circumferential face of the first guide bolt, and the second sealing element is attached via a groove formed on the circumferential face of the second guide bolt. The direct connection of the first sealing element in the groove of the first guide bolt, and the direct connection of the second sealing element in the groove of the second guide bolt, mean that no additional components are required. Also, the error rate during assembly, caused e.g. by insufficient tightening moment of components, which could lead to a loss of tightness of the first sealing element and second sealing element, is minimized.

It has proved advantageous if, in another aspect, the first sealing element is fixed to the first bolt guide via a first screw-in element in the region of the opening of the bolt guide hole, and the second sealing element is fixed to the second bolt guide via a second screw-in element in the region of the opening of the second bolt guide hole. The first sealing element is already premounted on the first guide bolt, and the second sealing element is premounted on the second guide bolt. During installation or removal of the brake caliper, the first screw-in element need merely be unscrewed from the first bolt guide and the second screw-in element unscrewed from the second bolt guide. The brake caliper can then be withdrawn from the first guide bolt and the second guide bolt of the wheel carrier without further assembly steps, such as releasing bolted connections.

In another aspect, the first screw-in element and the second screw-in element are configured as union nuts. Union nuts are distinguished in particular by their tightness in conjunction with a seal. The use of a first union nut, formed as a first screw-in element, with a first sealing element, seals the first bolt guide particularly well against the penetration of environmental influences, and the use of a second union nut, formed as a second screw-in element, with a second sealing element, seals the second bolt guide particularly well against the penetration of environmental influences.

In another aspect, the first sealing element has a clamping face and the clamping face is clamped between the first guide bolt and the first bolt guide, and the second sealing element has a clamping face, wherein the clamping face is clamped between the second guide bolt and the second bolt guide. During assembly, the clamping face of the first sealing element, together with the first guide bolt, is introduced or pressed into the first bolt guide of the brake caliper, and the clamping face of the second sealing element, together with the second guide bolt, is introduced or pressed into the second bolt guide of the brake caliper. This alternative embodiment of the first sealing element and the alternative embodiment of the second sealing element are provided for single-use mounting. Single-use mounting of the first sealing element and single-use mounting of the second sealing element ensure that it is no longer possible for environmental influences to penetrate into the first bolt guide and second bolt guide. Dismantling is possible only with destruction of the first sealing element and the second sealing element, whereby refitting of the possibly faulty first sealing element and/or refitting of the possibly faulty second sealing element is excluded.

In another aspect, the wheel carrier may be arranged on an outside of the brake caliper or the wheel carrier may be arranged on an inside of the brake caliper via a mounting opening of the brake caliper. With this design of wheel carrier, brake calipers of different configurations and different dimensions may be arranged on the wheel carrier. Also, the truck axle with the disc brake may be fitted to trucks with differently sized installation spaces because of the variable connection of the wheel carrier to the brake caliper.

### BRIEF DESCRIPTION OF THE DRAWINGS

Selected exemplary embodiments of the present disclosure are explained below with reference to the figures, in which:

FIG. 1 is a cross-sectional side view of a truck axle with a disc brake,

FIG. 2 perspective front view of the truck axle with a disc brake according to FIG. 1,

FIG. 3 is a cross-sectional side view a truck axle with a disc brake having a first guide bolt in another embodiment,

FIG. 3a is a further cross-sectional side view of a truck axle with a disc brake having a second guide bolt according to FIG. 3,

FIG. 4 is perspective front view of a truck axle with a disc brake according to FIG. 3 and FIG. 3a,

FIG. 5 is a perspective rear view of a truck axle with a disc brake in another embodiment,

FIG. 5a is a front perspective front view of a truck axle with a disc brake according to FIG. 5.

### DETAILED DESCRIPTION OF THE DRAWINGS

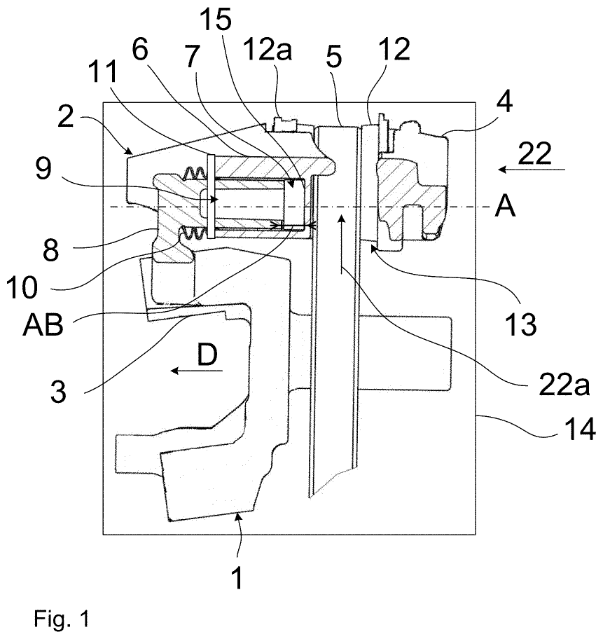

FIG. 1 shows a truck axle 1 with a disc brake 2 fitted to the truck axle 1. A wheel-side brake pad 12 and an application-side brake pad 12a, together with a brake disc 5, are fitted in the brake caliper 4 axially along a brake caliper axis A, via a mounting opening 13 of a brake caliper 4. The brake disc 5 is arranged axially between the wheel-side brake pad 12 and the application-side brake pad 12a, wherein the wheel-side brake pad 12 and the application-side brake pad 12a clamp the brake disc 5 during a braking process of a vehicle 14 in which the truck axle 1 with the disc brake 2 is fitted, and thus brake the vehicle 14.

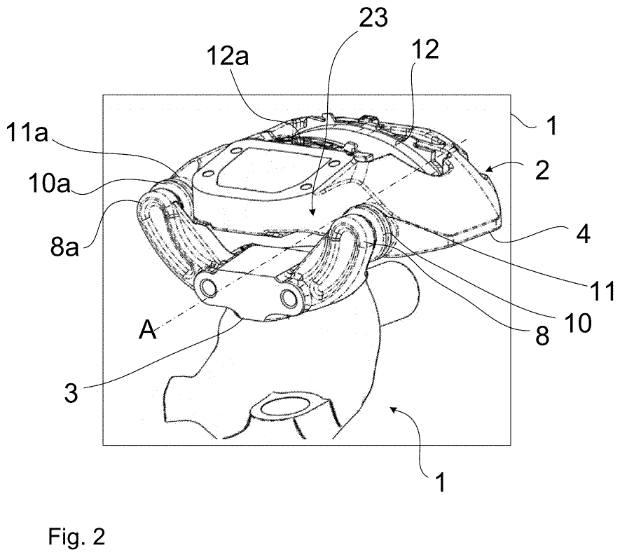

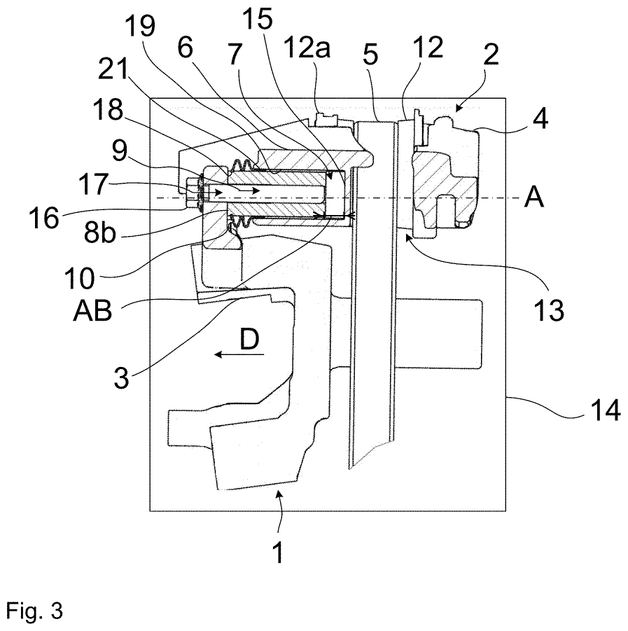

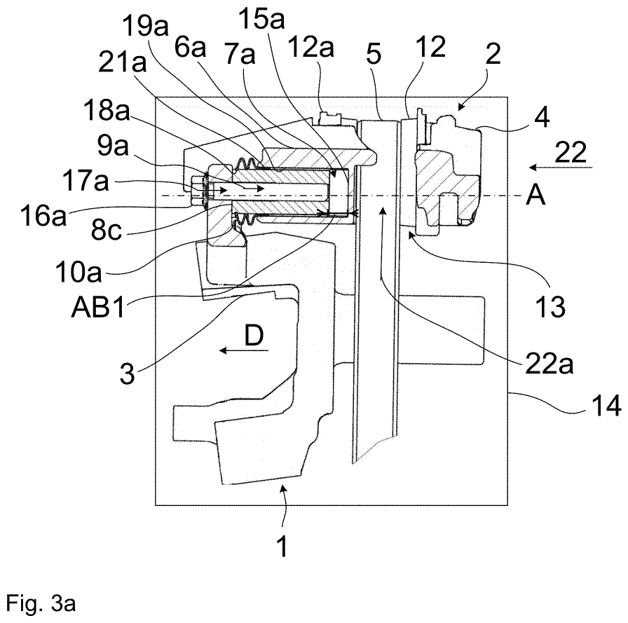

The brake caliper 4 furthermore has a first bolt guide 6 (FIG. 3) and a second bolt guide 6a (FIG. 3a). The first bolt guide 6 has a first bolt guide hole 7 (FIG. 3) formed as a blind hole, and the second bolt guide 6a has a second bolt guide hole 7a formed as a blind hole (FIG. 3a). To fix the disc brake 2 to the brake caliper 1 on an outside 22 of a wheel carrier 3, a first guide bolt 8 and a second guide bolt 8a (FIG. 2) are cast onto the wheel carrier 3 on a side of the wheel carrier 3 facing away from the wheel. The side facing away from the wheel is the side of the wheel carrier 3 which faces the vehicle 14. The first guide bolt 8 and the second guide bolt 8a are formed at right angles to a flange face 23 (FIG. 2) of the brake caliper 4.

The first guide bolt 8 engages axially inside the first bolt guide 6 via an opening 9 of the bolt guide hole 7 of the first bolt guide 6. The second guide bolt 8a (FIG. 2) engages axially inside the second bolt guide 6a via an opening 9a of the bolt guide hole 7a of the second bolt guide 6a. The movement of the brake caliper 4 is guaranteed by a distance AB (FIG. 1) of 20 mm between a base 15 of the bolt guide hole 7 of the first bolt guide 6 and the first guide bolt 8, and by a distance AB1 of 20 mm between a base 15a of the bolt guide hole 7a of the second bolt guide 6a and the second guide bolt 8a (FIG. 3a, in which the second guide bolt 8a is designated the second guide bolt 8c).

To protect against the penetration of environmental influences, a first sealing element 10, formed as a bellows as shown in FIG. 1, is arranged on the first guide bolt 8 by a first screw-in element 11 configured as a union nut. Also, a second sealing element 10a, formed as a bellows, is arranged on the second guide bolt 8a by a second screw-in element 11a configured as a union nut (FIG. 2). After arranging the disc brake 2 on the wheel carrier 3, the first union nut 11 is screwed onto the opening 9 of the bolt guide hole 7 of the first bolt guide 6, and the second union nut 11a is screwed onto the opening 9a of the bolt guide hole 7a of the second bolt guide 6a (FIG. 2). For dismantling D (FIG. 1 and FIG. 3), the first union nut 11 is unscrewed from the first bolt guide 6 and the second union nut 11a is unscrewed from the second bolt guide 6a. Then the entire disc brake 2 may be withdrawn as one piece from the wheel carrier 3 of the truck axle.

FIG. 2 shows a perspective front view of the truck axle 1 with the disc brake 2. The brake disc 5 is not shown, in order to clarify the connection of the brake caliper 4 to the wheel carrier 3. In particular as shown the first guide bolt 8 of the wheel carrier 3 with the first sealing element 10 and, arranged axially parallel thereto, the second guide bolt 8a of the wheel carrier 3 with the second sealing element 10a.

FIG. 3 and FIG. 3a show a second embodiment of the truck axle 1 with the disc brake 2 from FIG. 1 and FIG. 2. In the second embodiment, the disc brake 2 is secured to the wheel carrier 3 via a first bolt screw 16 and a second bolt screw 16a. For mounting, according to FIG. 3, a first guide bolt 8b (not connected to the wheel carrier 3) is brought into the opening 9 of the bolt guide hole 7 of the first bolt guide 6. One side of the first sealing element 10, formed as a bellows, is fixed to the first guide bolt 8b via a groove 18 of the first guide bolt 8b. The second side of the first sealing element 10 opposite the first side is configured as a clamping face 21, and the clamping face 21 is partially arranged in the bolt guide hole 7 of the first bolt guide 6 between the first guide bolt 8b and an inner wall 19 of the first bolt guide 6. Then the first bolt screw 16 engages, via a first passage opening 17 of the wheel carrier 3, in the first guide bolt 8b (not connected to the wheel carrier 3), and fixes the first guide bolt 8b to the wheel carrier 3. Similarly, FIG. 3a shows a second guide bolt 8c (not connected to the wheel carrier 3) which is brought into the opening 9a of the bolt guide hole 7a of the second bolt guide 6a. One side of the second sealing element 10a, formed as a bellows, is fixed to the second guide bolt 8c via a groove 18a of the second guide bolt 8c. The second side of the second sealing element 10a opposite the first side is configured as a clamping face 21a, and the clamping face 21a is partially arranged in the bolt guide hole 7a of the second bolt guide 6a between the second guide bolt 8a and an inner wall 19a of the second bolt guide 6a. Then the second bolt screw 16a engages, via a second passage opening 17a of the wheel carrier 3, in the second guide bolt 8c (which is not connected to the wheel carrier 3), and fixes the second guide bolt 8c to the wheel carrier 3.

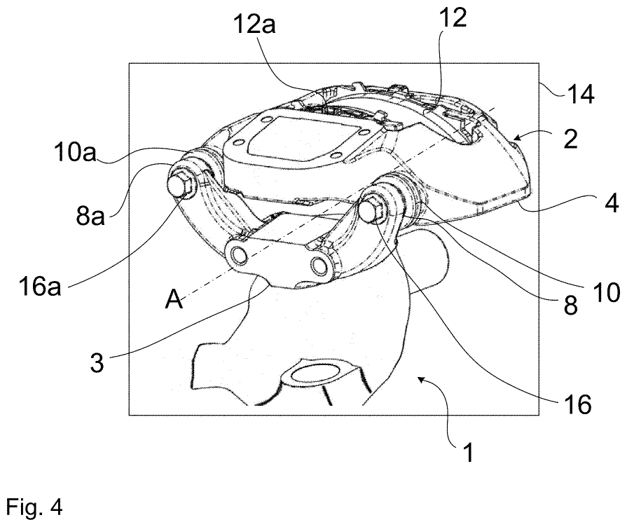

FIG. 4 shows a perspective front view of the second embodiment of the truck axle 1 with the disc brake 2 from FIG. 3 and FIG. 3a. The brake disc 5 is not shown, in order to clarify the connection of the brake caliper 4 to the wheel carrier 3. FIG. 4 again illustrates that the brake caliper 4 is connected to the wheel carrier 3 by the first bolt guide 6 (FIG. 3) via a first bolt screw 16, and the second bolt guide 6a is connected to the wheel carrier 3 via the second bolt screw 16a. The brake caliper 4 is arranged on the wheel carrier 3 so as to be rotationally inhibited by the first bolt screw 16 and the second bolt screw 16a.

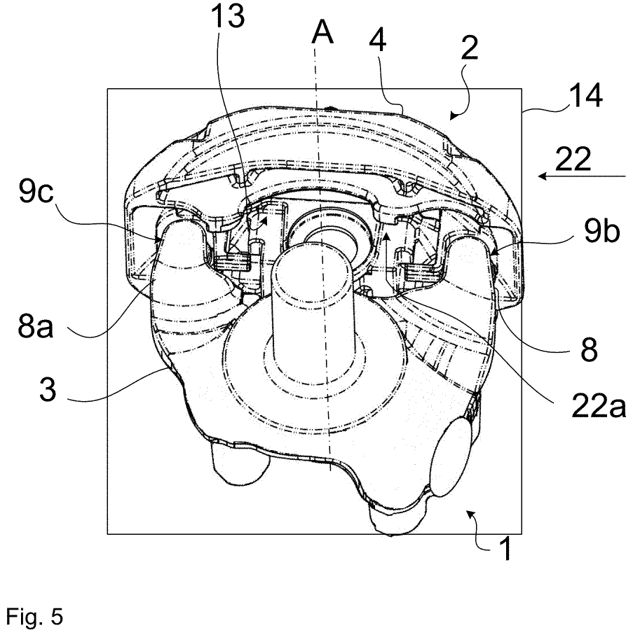

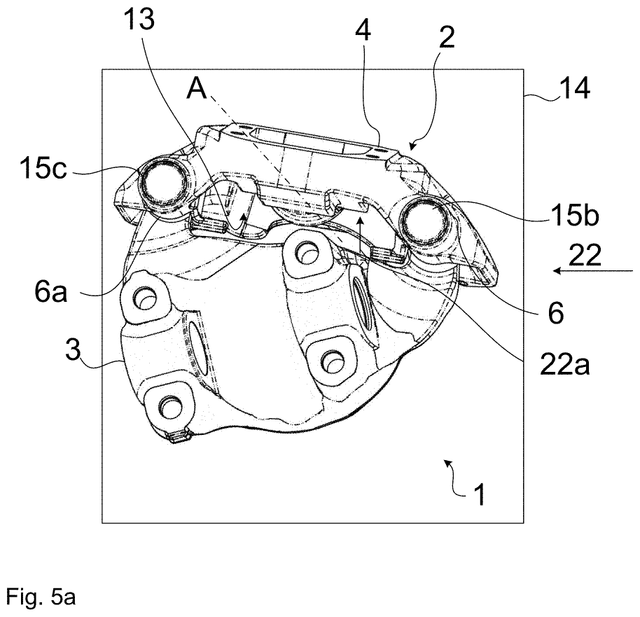

FIG. 5 and FIG. 5a show a third embodiment of the truck axle 1 with a disc brake 2 according to FIG. 1 to FIG. 4. The brake disc 5, the wheel-side brake pad 12 and the application-side brake pad 12a are not shown, in order to clarify the connection of the brake caliper 4 to the wheel carrier 3.

In the third embodiment, the arrangement of the wheel carrier 3 on an inside 22a of the brake caliper 4 via the mounting opening 13 of the brake caliper 4 is shown. The first bolt guide 6 (FIG. 3) has an inner opening 9b (FIG. 5) of the bolt guide hole 7 (FIG. 1) and a base 15b (FIG. 5a) facing away from the wheel carrier 3. The second bolt guide 6a (FIG. 3a) again has an inner opening 9c (FIG. 5) of the bolt guide hole 7a (FIG. 3a) and a base 15c (FIG. 5a) facing away from the wheel carrier 3. The first guide bolt 8 is arranged on the brake caliper 4 via the inner opening 9b of the bolt guide hole 7 of the first bolt guide 6, and the second guide bolt 8a is arranged on the brake caliper 4 via the inner opening 9c of the bolt guide hole 7a of the second bolt guide 6a.

FIGS. 5 and 5a show opposite sides of the same embodiment, and therefore the bases 15b and 15c define the interior axial space between the base of the bolt guide holes 7 and 7a and the end of the guide bolts 8 and 8a. FIGS. 5 and 5a therefore show how the guide bolts 8 and 8a can be received in the bolt guides 6 and 6a in the opposite direction from that shown in FIGS. 1, 3, and 3a.

While the above description constitutes the preferred embodiments of the present invention, it will be appreciated that the invention is susceptible to modification, variation and change without departing from the proper scope and fair meaning of the accompanying claims.

What is claimed is:

1. A truck axle (1) with a disc brake (2), comprising:
a wheel carrier (3) for arrangement of the disc brake (2) on the truck axle (1),
wherein the disc brake (2) comprises a brake caliper (4) with a first bolt guide (6) arranged in the direction of a brake disc (5) and with a second bolt guide (6a) arranged in the direction of the brake disc (5),
wherein the brake caliper (4) is arranged on the wheel carrier (3) via the first bolt guide (6) and via the second bolt guide (6a).

2. The truck axle (1) as claimed in claim 1, wherein the first bolt guide (6) has a bolt guide hole (7) which is closed in the direction of the brake disc (5), and the second bolt guide (6a) has a bolt guide hole (7a) which is closed in the direction of the brake disc (5).

3. The truck axle (1) as claimed in claim 1, wherein the first bolt guide (6) has a bolt guide hole (7) which is closed facing away from the brake disc (5) and the second bolt guide (6a) has a bolt guide hole (7a) which is closed facing away from the brake disc (5).

4. The truck axle (1) as claimed in claim 1, wherein the wheel carrier (3) has a first guide bolt (8, 8b) for receiving the first bolt guide (6) thereon and the wheel carrier (3) has a second guide bolt (8a, 8c) for receiving the second bolt guide (6a) thereon.

5. The truck axle (1) as claimed in claim 4, wherein the first guide bolt (8) and the second guide bolt (8a) are arranged on the wheel carrier (3) by forging or casting.

6. The truck axle (1) as claimed in claim 4, wherein the first guide bolt (8b) is arranged on the wheel carrier (3) via a first bolt screw (16) and the second guide bolt (8c) is arranged on the wheel carrier (3) via a second bolt screw (16a).

7. The truck axle (1) as claimed in claim 4, wherein the first guide bolt (8, 8b) is partially arranged in the bolt guide hole (7) of the first bolt guide (6) and the second guide bolt (8a, 8c) is partially arranged in the bolt guide hole (7a) of the second bolt guide (6a) to define a space between a base of the guide holes and the ends of the guide bolts.

8. The truck axle (1) as claimed in claim 4, wherein the first guide bolt (8) is formed at a right angle to a flange face (23) of the brake caliper (4), and the second guide bolt (8a) is formed at a right angle to the flange face (23) of the brake caliper (4).

9. The truck axle (1) as claimed in claim 6, wherein the first guide bolt (8b) and the second guide bolt (8c) are formed in the direction of the brake caliper axis (A).

10. The truck axle (1) as claimed in claim 1, wherein the brake caliper (4) is mounted on the wheel carrier (3) via the first bolt guide (6) and via the second bolt guide (6a) so as to slide axially along the brake caliper axis (A).

11. The truck axle (1) as claimed in claim 6, wherein a first sealing element (10) is arranged along the circumference of the first guide bolt (8, 8b) in the region of an opening (9, 9b) of the bolt guide hole (7), and a second sealing element (10a) is arranged along the circumference of the second guide bolt (8a, 8c) in the region of an opening (9a, 9c) of a bolt guide hole (7a).

12. The truck axle (1) as claimed in claim 11, wherein the first sealing element (10) is arranged via a groove (18) formed in a circumferential face of the first guide bolt (8, 8b), and the second sealing element (10a) is arranged via a groove (18a) formed in a circumferential face of the second guide bolt (8a, 8c).

13. The truck axle (1) as claimed in claim 11, wherein the first sealing element (10) is fixed to the first bolt guide (6) via a first screw-in element (11) in the region of the opening (9) of the bolt guide hole (7), and the second sealing element (10a) is fixed to the second bolt guide (6a) via a second screw-in element (11a) in the region of the opening (9a) of the second bolt guide hole (7a).

14. The truck axle (1) as claimed in claim 13, wherein the first screw-in element (11) and the second screw-in element (11a) are union nuts.

15. The truck axle (1) as claimed in claim 11, wherein the first sealing element (10) has a clamping face (21) and the clamping face (21) is clamped between the first guide bolt (8, 8b) and the first bolt guide (6), and the second sealing element (10a) has a clamping face (21a) and the clamping face (21a) is clamped between the second guide bolt (8a, 8c) and the second bolt guide (6a).

16. The truck axle (1) as claimed in claim 1, wherein the wheel carrier (3) is arranged on an outside (22) of the brake caliper (4).

17. The truck axle (1) as claimed in claim 1, wherein the wheel carrier (3) is arranged on an inside (22a) of the brake caliper (4) via a mounting opening (13) of the brake caliper (4).

18. The truck axle (1) as claimed in claim 1, wherein the brake caliper (4) is directly connected to the wheel carrier (3) without an additional brake carrier.

19. The truck axle (1) as claimed in claim 1, wherein the first guide bolt (8b) and the second guide bolt (8c) are independent components and are fitted in the first bolt guide (6) and in the second bolt guide (6a) independently of the wheel carrier (3).

20. The truck axle (1) as claimed in claim 1, wherein the brake caliper (4) is arranged to shift axially relative to the wheel carrier (3) in response to brake pad wear.
